(19) United States
(12) Patent Application Publication
(10) Pub. No.: US 2025/0316933 A1
(43) Pub. Date: Oct. 9, 2025

(54) SHIELD CONNECTOR

(71) Applicant: J.S.T. Mfg. Co., Ltd., Tokyo (JP)

(72) Inventors: Koji WADA, Miyoshi-shi (JP); Kazumasa OI, Miyoshi-shi (JP)

(73) Assignee: J.S.T. Mfg. Co., Ltd., Tokyo (JP)

(21) Appl. No.: 19/098,847

(22) Filed: Apr. 2, 2025

(30) Foreign Application Priority Data
Apr. 3, 2024 (JP) 2024-060414
Mar. 7, 2025 (JP) 2025-036319

(51) Int. Cl. H01R 13/6592

(52) U.S. Cl. CPC H01R 13/6592

(57) ABSTRACT

To provide a shield connector capable of simultaneously inserting terminals into an inner housing, even when the terminals wire-connected to the core wires of the pair of electric wires are twisted. A connector 10 includes: a pair of terminals 1, 1 wire-connecting core wires Wc; an inner housing 2 holding the pair of terminals 1, 1; a metal shell 3 covering exposed portions of a pair of electric wires W, W in a tightly close-contact manner; and a cover shell 4 connected serially with the metal shell 3. The metal shell 3 includes a pair of terminal introduction holes 32h, 32h partially communicating with each other at outer edges thereof. Each terminal 1 includes a plurality of contact lances 13 formed on the electric wire connection portion 1a side and protuberating radially outward from of the terminal 1. The inner housing 2 includes a pair of housing lances 22r, 22r protruding forwardly and latchable to the contact lances 13.

This application is based on and claims the benefit of priority from Japanese Patent Application Nos. 2024-060414 and 2025-036319, respectively filed on 3 Apr. 2024 and 7 Mar. 2025, the contents of which are incorporated herein by reference.

### BACKGROUND OF THE INVENTION

### Field of the Invention

The present invention relates to a shield connector. The invention particularly relates to a structure of a shield connector that can be attached to an end of a shielded differential cable including a pair of electric wires each having an insulation-coated core, a braided wire covering the electric wires, and an insulation sheath covering the braided wire.

### Related Art

A shielded differential cable such as a shielded twisted quad (STQ) cable or a shielded twisted pair (STP) cable covers two pairs of electric wires with a braided wire to protect electric signals transmitted over core wires from unwanted electromagnetic waves.

For a wire harness transmitting electric signals to electronic devices mounted on an automobile, a shield connector attached to an end of a shielded differential cable (will be hereinafter referred to as a shielded cable) is often used because it is less susceptible to noise and capable of transmitting high frequency signals.

A shield connector with high assembly reliability, attachable to a terminal end of an STP cable, is known (for example, see Patent Document 1).

Patent Document 1: Japanese Unexamined Patent Application, Publication No. 2023-4366

### SUMMARY OF THE INVENTION

In the shield connector disclosed in Patent Document 1, a front portion of a terminal is inserted into a terminal accommodation chamber in a front portion of a housing, and a rear portion of the terminal is inserted into an open terminal accommodation chamber in a rear portion of the housing. A retainer is mounted on the housing by sliding the retainer in the terminal insertion direction such that a retainer main body covers the open terminal accommodation chamber at the rear portion of the housing. Even if a terminal is in a partially inserted state, the terminal pressed by a pressing portion of the retainer during sliding installation is corrected into a fully inserted state latched to a latching portion. Therefore, the shield connector disclosed in Patent Document 1 provides high assembly reliability.

In the shield connector disclosed in Patent Document 1, a terminal is composed of a hollow box-shaped terminal connection portion and an electric wire crimp portion that crimps the core wires of the electric wires. Furthermore, a bridging portion axially bridges the terminal connection portion and the electric wire crimp portion. The terminal connection portion includes a semi-conical latching protrusion (commonly called a “contact lance”) protuberating from the upper surface. When the retainer is mounted onto an inner housing, the latching protrusion latches to a housing lance (latching portion) formed inside the inner housing.

However, when inserting a pair of terminals simultaneously into the inner housing, the electric wires may be twisted. Consequently, during electric wire crimping, it is not easy to align the latching protrusions provided on the pair of terminals in the same outward radial direction. When the latching protrusions of the left and right terminals differ in orientation, it becomes necessary to provide direction-regulating members on the terminals.

Thus, there is a need for a shield connector attachable to the terminal end of a shielded cable that includes a pair of electric wires and a braided wire covering the pair of electric wires, in which the terminals can be simultaneously inserted into an inner housing even when there is twisting in the terminals wire-connected to the core wires of the pair of electric wires. The above considerations form the technical problems addressed by the present invention.

In view of the above problems, it is an object of the present invention to provide a shield connector attachable to the terminal end of a shielded cable that includes a pair of electric wires and a braided wire covering the pair of electric wires, in which the terminals wire-connected to the core wires of the pair of electric wires can be simultaneously inserted into the inner housing even when the terminals are twisted.

The inventors of the present invention have conceived that simultaneous insertion of terminals is possible even when orientations of latching protrusions (contact lances) differ between the left and right terminals by configuring the terminals with a plurality of latching protrusions and providing corresponding latching portions (housing lances) in the inner housing. Based on this concept, the inventors arrived at the following novel shield connector.
(1) A shield connector attachable to a terminal end of a shielded differential cable that includes a pair of electric wires each including a core wire insulated by an insulating covering, a braided wire covering the pair of electric wires, and an insulation sheath covering the braided wire, in which the shield connector includes: cylindrical terminals wire-connecting the core wires; an inner housing internally holding a pair of the terminals; and a metal shell electrically connected to the braided wire, the metal shell covering an exposed portion of the pair of electric wires extending from a terminal end of the braided wire to the terminals in a tightly close-contact manner, and the metal shell including a pair of terminal introduction holes partially communicating with each other at outer edges thereof, in which each of the terminals includes: an electric wire connection portion provided at one end thereof, including a conductor barrel configured to connect the core wire by crimping; a terminal connection portion provided at another end thereof, including a pair of clipping pieces connectable to a counterpart terminal; and a plurality of latching protrusions provided on a side of the electric wire connection portion and protuberating radially outward from an outer circumference of the terminal, and in which the inner housing includes latching portions protruding forwardly and latchable to the latching protrusions.
(2) The shield connector as described in (1), in which the plurality of latching protrusions comprise three protrusions arranged evenly around the outer circumference of the terminal, and the latching portions comprise a pair of opposing semicircular walls.
(3) The shield connector as described in (1) or (2), further including an outer housing with an upper surface including a locking arm fittable to a counterpart connector, the outer housing internally holding the metal shell in a state of being connected to the shielded differential cable, in which the outer housing includes a first positioning member configured to maintain a locked state of the locking arm.
(4) The shield connector as described in (3), in which the outer housing further includes a second positioning member inserted from a lower surface toward an outer circumference of the metal shell, thereby restricting axial movement of the metal shell relative to the outer housing.
(5) The shield connector as described in any one of (1) to (4), further including an elliptical cylindrical cover shell serially connected to the metal shell and covering a front portion of the metal shell.

The shield connector according to the present invention includes a plurality of latching protrusions (contact lances) provided at terminals and latching portions (housing lances) provided within an inner housing, thereby allowing for simultaneously inserting terminals even when the latching protrusions of left and right terminals differ in orientation.

### BRIEF DESCRIPTION OF THE DRAWINGS

FIG. 1 is a front perspective view illustrating the configuration of a shield connector according to an embodiment of the present invention;

FIG. 2 is a rear perspective view illustrating the configuration of the shield connector according to the embodiment;

FIG. 3 is a right-side view illustrating the configuration of the shield connector according to the embodiment;

FIG. 4 is a vertical cross-sectional view illustrating the configuration of the shield connector according to the embodiment taken along the line A-A shown in FIG. 3;

FIG. 5 is an exploded perspective view illustrating the configuration of the shield connector according to the embodiment, showing a terminal assembly before being assembled into an outer housing;

FIG. 6A is an exploded perspective view illustrating the configuration of the shield connector according to the embodiment, showing a first positioning member and a second positioning member before being assembled into the outer housing on the left side of the view and internal components of the shield connector on the right side of the view;

FIG. 6B is an exploded perspective view illustrating the configuration of the shield connector according to the embodiment, showing the members shown on the left side of FIG. 6A assembled together and the components shown on the right side of FIG. 6A assembled together;

FIG. 7 is an exploded perspective assembly view illustrating the configuration of the shield connector according to the embodiment, in a state before assembling a terminal-treated shielded differential cable into the terminal assembly;

FIG. 8A is a cross-sectional view illustrating the configuration of the shield connector according to the embodiment taken along the line B-B shown in FIG. 4;

FIG. 8B is a cross-sectional view illustrating the configuration of the shield connector according to the embodiment taken along the line A-A shown in FIG. 4;

FIG. 8C is a cross-sectional view illustrating the configuration of the shield connector according to the embodiment, with the outer housing removed from the configuration shown in FIG. 8B;

FIG. 8D is a cross-sectional view illustrating the configuration of the shield connector according to the embodiment, with the outer housing removed from the configuration shown in FIG. 8A;

FIG. 9 is an exploded perspective view illustrating the whole components of the shield connector according to the embodiment;

FIG. 10A is a view illustrating the configuration of the shield connector according to the embodiment, showing a metal shell in a perspective view;

FIG. 10B is a view illustrating the configuration of the shield connector according to the embodiment, showing the metal shell seen from the rear side;

FIG. 10C is a view illustrating the configuration of the shield connector according to the embodiment, showing the metal shell seen from the top;

FIG. 10D is a view illustrating the configuration of the shield connector according to the embodiment, showing the shield connector in a perspective view;

FIG. 10E is a view illustrating the configuration of the shield connector according to the embodiment, showing the metal shell and a cover shell joined with a shielded cable in a perspective view;

FIG. 11A is a view illustrating an assembly process of the shield connector according to the embodiment, showing a shielded cable before termination;

FIG. 11B is a view illustrating the assembly process of the shield connector according to the embodiment, showing the shielded cable with an insulation sheath partially removed from the end of the shielded cable;

FIG. 11C is a view illustrating the assembly process of the shield connector according to the embodiment, showing the shielded cable with a ferrule set on the outer circumference of a braided wire before being crimped;

FIG. 11D is a view illustrating the assembly process of the shield connector according to the embodiment, showing the shielded cable with the ferrule crimped to the outer circumference of the braided wire;

FIG. 11E is a view illustrating the assembly process of the shield connector according to the embodiment, showing the shielded cable with the braided wire folded over the outer circumference of the ferrule;

FIG. 11F is a view illustrating the assembly process of the shield connector according to the embodiment, showing the shielded cable with a predetermined length of metal foil covering the outer circumference of a pair of electric wires removed;

FIG. 11G is a view illustrating the assembly process of the shield connector according to the embodiment, showing the shielded cable with an insulating covering removed from the ends of the electric wires;

FIG. 11H is a view illustrating the assembly process of the shield connector according to the embodiment, showing the shielded cable of FIG. 11G seen from the right side;

FIG. 11I is a view illustrating the assembly process of the shield connector according to the embodiment, showing the ferrule before crimping the ferrule seen from the front;

FIG. 11J is a view illustrating the assembly process of the shield connector according to the embodiment, showing the crimped ferrule alone seen from the front;

FIG. 11K is a view illustrating the assembly process of the shield connector according to the embodiment, showing the ferrule crimped to the electric wires; and

FIG. 12 is a perspective view illustrating the configuration of the shield connector according to the embodiment, in a state viewed from the front side.

### DETAILED DESCRIPTION OF THE INVENTION

An embodiment of the present invention will be described below with reference to the drawings.

### Configuration of Shield Connector

The configuration of a shield connector according to an embodiment of the present invention will be described first. (General Configuration)

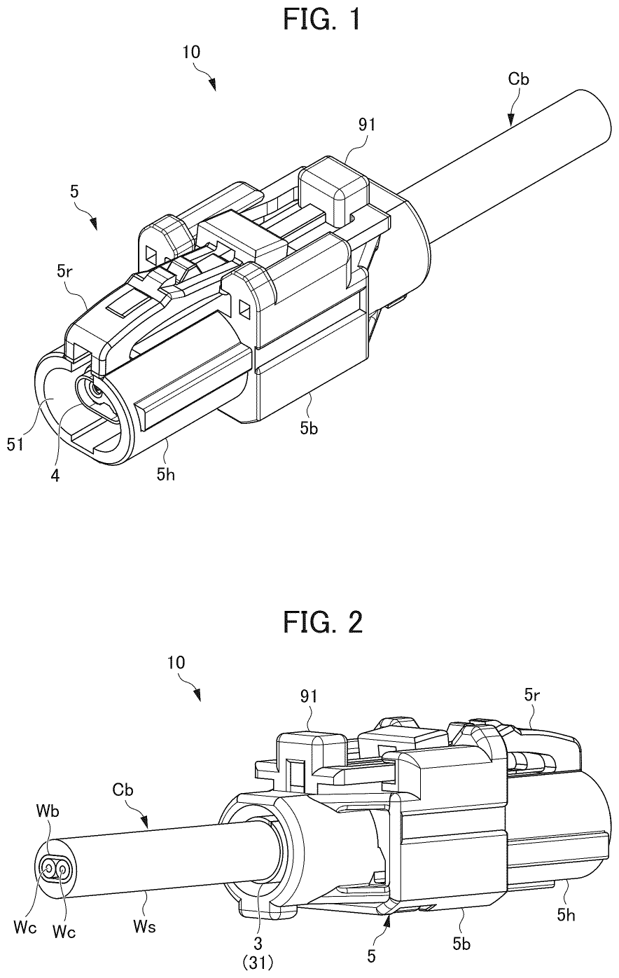

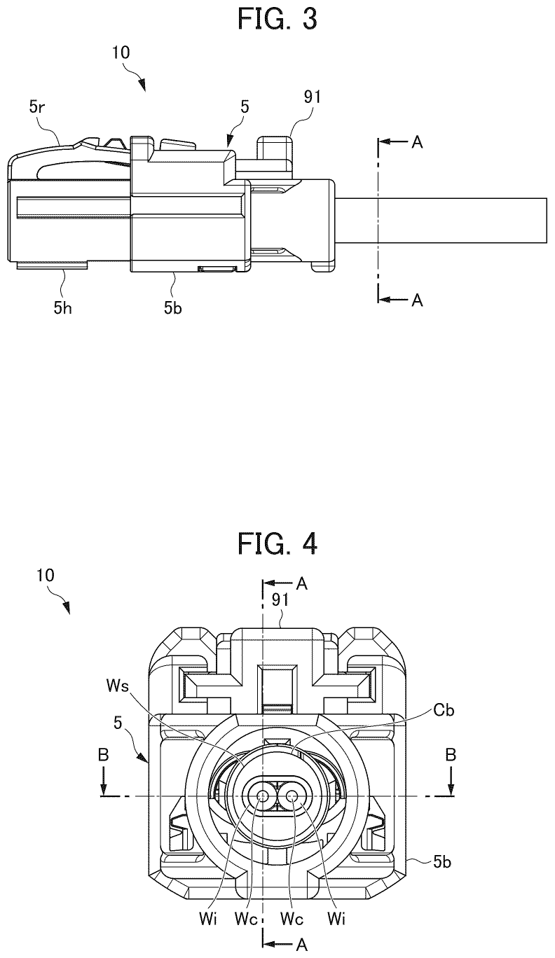

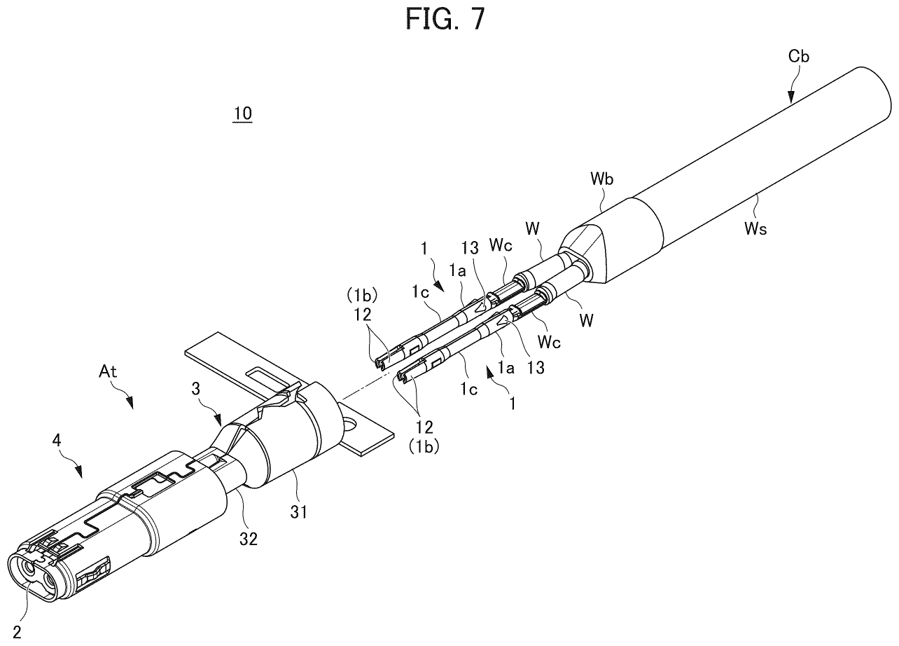

Referring to FIGS. 1 to 7, a shield connector 10 according to the embodiment of the present invention (will be hereinafter abbreviated as a connector) is attachable to an end of a shielded differential cable (will be hereinafter referred to as a shielded cable) Cb. The shielded cable Cb includes a pair of electric wires W, W, a braided wire Wb, and an insulation sheath Ws. Each electric wire W has an insulation-coated core wire Wc. The braided wire Wb covers the circumference of the pair of electric wires W, W. The insulation sheath Ws covers the braided wire Wb (see FIG. 7 or 9 and FIGS. 11A to 11H).

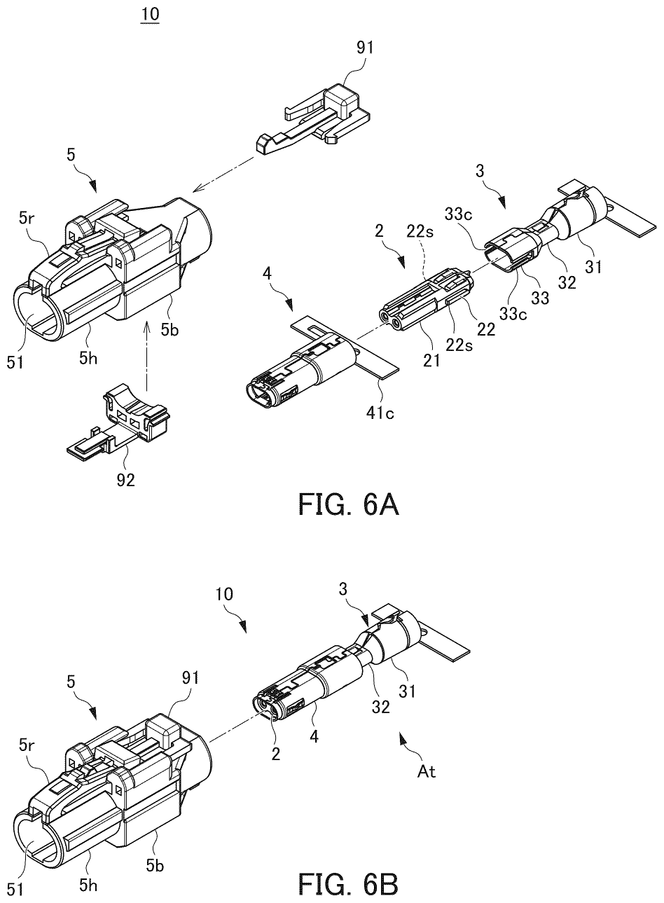

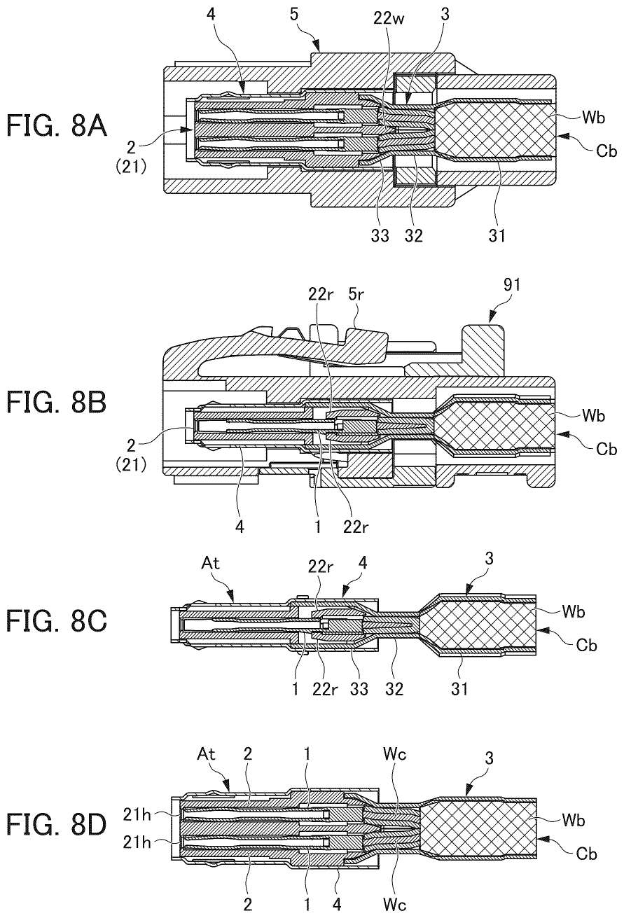

Referring to FIGS. 6A, 6B, 7, and 9, the connector 10 includes a pair of terminals 1, 1 and an elliptical cylindrical inner housing 2. The connector 10 also includes a metal shell 3 and a cover shell 4, both in the shape of an elliptic tube. Each terminal 1 is connected to a corresponding one of the core wires Wc (see FIG. 7 or 8D). The inner housing 2 holds the pair of terminals 1, 1 therein (see FIG. 8A or 8B).

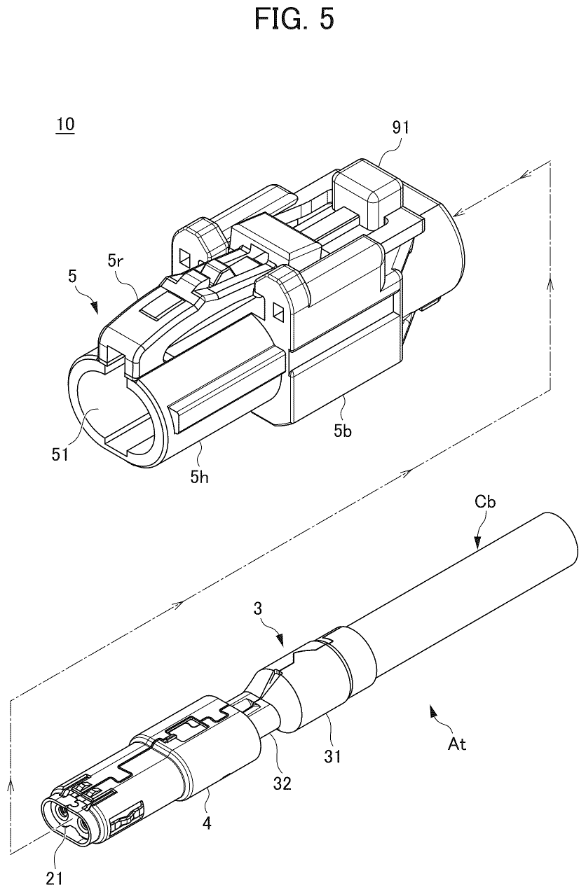

Referring to FIG. 5 or 6B, the cover shell 4 is connected to the metal shell 3 in series. The cover shell 4 covers the inner housing 2 and a front portion 21 of the metal shell 3 (see FIG. 8A or 8B).

Referring to FIGS. 8A to 8D, the metal shell 3 is electrically connected to the braided wire Wb. The metal shell 3 covers an exposed portion of the pair of electric wires W, W ranging from the end of the braided wire Wb to the terminals 1 to be in close contact with the exposed portion. The metal shell 3 includes a crimp portion 31, a terminal conduction hole portion 32, and a connecting portion 33 (refer to FIG. 7 or FIGS. 8A to 8D). The crimp portion 31 to the connecting portion 33 are continuous in an axial direction.

Referring to FIG. 8A, the crimp portion 31 is crimped to the braided wire Wb from the outer circumference. Referring to FIG. 8A or 8C, the terminal conduction hole portion 32 extends through exposed portions of the pair of electric wires W, W. Referring to FIG. 8C, the connecting portion 33 covers the inner housing 2 from the outer circumference.

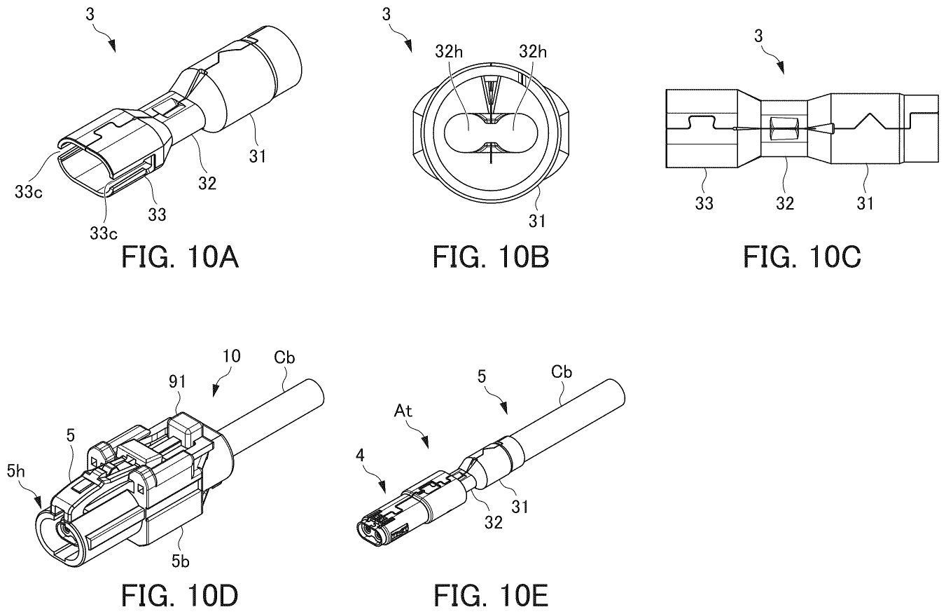

Referring to FIGS. 10A to 10C, the crimp portion 31 is in the shape of an elliptic tube. The terminal conduction hole portion 32 continuous with the crimp portion 31 has a pair of terminal introduction holes 32h, 32h. In the illustrated example, the terminal conduction hole portion 32 is in the shape of an elliptic tube and is thinner than the crimp portion 31. Wall portions of the terminal conduction hole portion 32 facing each other across the major axis are recessed inward at the center to approach each other. This forms the pair of terminal introduction holes 32h, 32h in the terminal conduction hole portion 32. That is, in the illustrated example, the pair of terminal introduction holes 32h, 32h is an inner cavity of the elliptical cylindrical terminal conduction hole portion 32. The terminal introduction holes 32h, 32h are thinner than the crimp portion 31 and partially connected to each other at an outer edge. Referring to FIG. 8A or 8B, the inner housing 2 has a wedge piece 22w protruding from an end of the inner housing 2. The wedge piece 22w separates the pair of electric wires W, W introduced into the inner housing at a predetermined pitch.

Referring to FIGS. 8A to 8D, or FIGS. 10A to 10E, with the shield connector 10 according to the embodiment, the terminal introduction holes 32h, 32h for introducing the exposed portions of the insulating coverings of the pair of electric wires W, W are formed into an “infinity symbol” shape, whereby the insulating coverings Wi of the electric wires W tightly close-contact the inner wall of the terminal introduction holes 32h. This reduces impedance, enabling satisfactory signal transmission in high-frequency ranges.

With the shield connector 10 of the present invention, the electric wires W led by the terminals 1 can be easily inserted into the terminal introduction holes 21h, and the wedge piece 22w protrudes from the end of the inner housing 2, whereby the terminal ends of the tightly close-contacted pair of electric wires W, W can be spaced apart at a predetermined pitch.

Referring to FIGS. 7 or 9 and 12, the terminals 1 are formed with a plurality of latching protrusions (hereinafter referred to as “contact lances”) 13 on the electric wire connection portion 1a side. The contact lances 13 protuberate radially outward from the outer circumference of the terminals 1.

On the other hand, referring to FIG. 8B, in the inner housing 2, a pair of latching portions (hereinafter referred to as “housing lances”) 22r, 22r latchable to the contact lances 13 protrude forwardly. The contact lances 13 include three lances evenly spaced around the outer circumference of the terminals 1, while the housing lances 22r, 22r include a pair of opposing semicircular walls.

Referring to FIG. 8A, when the pair of terminals 1, 1 are inserted into the terminal introduction holes 21h, 21h, the wedge piece 22w is relatively inserted between the electric wires W, W, and upon stopping the progression of the pair of terminals 1, 1, at least one or two of the three contact lances 13 can be securely latched to the housing lances 22r.

With the shield connector 10 according to the embodiment, the terminals 1 can be simultaneously inserted into the inner housing 2, even when there is twisting in the terminals 1 wire-connected to the core wires Wc of the pair of electric wires W, W.

### (Configuration of Terminal)

The configuration of the terminals 1 according to the embodiment will be described below. Referring to FIG. 7, each terminal 1 is fixed to the end of the corresponding core wires Wc. The terminal 1 has an electric wire connection portion 1a consisting of a conductor barrel at one end. Crimping the conductor barrel to the core wire Wc joins the terminal 1 and the electric wire W to be electrically connectable.

Referring to FIG. 7, the terminal 1 has a terminal connection portion 1b consisting of a pair of clipping pieces 12, 12 at the other end. The terminal connection portion 1b is formed in the shape of a cylinder having a slit. The terminal connection portion 1b can function as an open entry that protects the terminal from deformation at the time of insertion of a counterpart terminal.

Referring to FIG. 7, the terminal connection portion 1b allows a pin-shaped male contact of a counterpart terminal (not shown) to be introduced from a front opening of the terminal connection portion 1b. Thus, the counterpart terminal which is not shown and the terminal 1 are electrically connected. Although FIG. 7 discloses the terminal 1 as a female terminal, the terminal 1 can be a pin-shaped male terminal.

Referring to FIG. 7, the terminal 1 includes at least one pyramidal contact lance 13 protuberating radially from the outer circumference on the electric wire connection portion 1a side (refer to FIG. 7). When the terminal 1 is inserted into the inner housing 2, the contact lance 13 is latched to the housing lance 22r (latching portion) provided on the inner wall of the inner housing 2 (refer to FIG. 8B), thereby preventing the terminal 1 from detaching when the counterpart terminal is inserted.

Referring to FIG. 7 or 8B, and 12, in the present embodiment, the plurality of contact lances (latching protrusions) 13 include three lances evenly spaced around the outer circumference of the terminal 1. Referring to FIG. 12, the central portions of the plurality of contact lances 13 are angled at a 120-degree angle. Since the housing lances (latching portions) 22r, 22r consist of the pair of opposing semicircular walls (refer to FIG. 8B), at least one or two of the three contact lances 13 can be securely latched to the housing lances 22r.

Referring to FIG. 7, the terminal 1, which is made of a conductive metal plate, can be obtained by forming a developed conductive metal plate into a cylindrical shape. The terminal 1 may be obtained by processing a conductive metal rod into a cylindrical shape.

### (Configuration of Inner Housing)

The configuration of the inner housing 2 according to the embodiment will be described below. Referring to FIGS. 6A, 8A to 8D, and 9, the inner housing 2, which is made of an insulative synthetic resin, can be obtained by molding the insulative synthetic resin into a desired shape.

Referring to FIG. 8D, a pair of terminal introduction holes 21h, 21h is open in a front portion 21 of the inner housing 2 (see FIG. 6A). The counterpart terminals which are not shown can be inserted into the terminal introduction holes 21h from the front side. The terminals 1 joined with the electric wires W can be inserted into the terminal introduction holes 21h from a rear portion 22.

Referring to FIGS. 8A to 8D, with the terminals 1 housed in the terminal introduction holes 21h, the terminal connection portions 1b are located to face the front openings of the terminal introduction holes 21h.

Referring to FIG. 6A, the inner housing 2 has a pair of ribs 22s, 22s protruding in opposing directions from its outer circumference.

Referring to FIG. 6A, both sides of the connecting portion 33 of the metal shell 3 are cut to form a pair of rectangular notches 33c, 33c that fits with the pair of ribs 22s, 22s. When the rear portion 22 of the inner housing 2 is inserted into the metal shell 3, the ribs 22s fit into the notches 33c, determining the position of the inner housing 2 relative to the metal shell 3 in the axial direction of the metal shell 3. This allows the inner housing 2 and the metal shell 3 to be correctly connected in series in the axial direction.

### (Configuration of Metal Shell)

The configuration of the metal shell 3 according to the embodiment will be described below. Referring to FIGS. 5 to 10E, the metal shell 3, which is made of a conductive metal plate, is obtained by forming a developed conductive metal plate into an elliptic tube shape.

Referring to FIGS. 6A, 6B, 7, and 8A to 8D, the metal shell 3 has the crimp portion 31, the terminal conduction hole portion 32, and the connecting portion 33 that are continuous in the axial direction. The crimp portion 31 is formed at a proximal end of the metal shell 3.

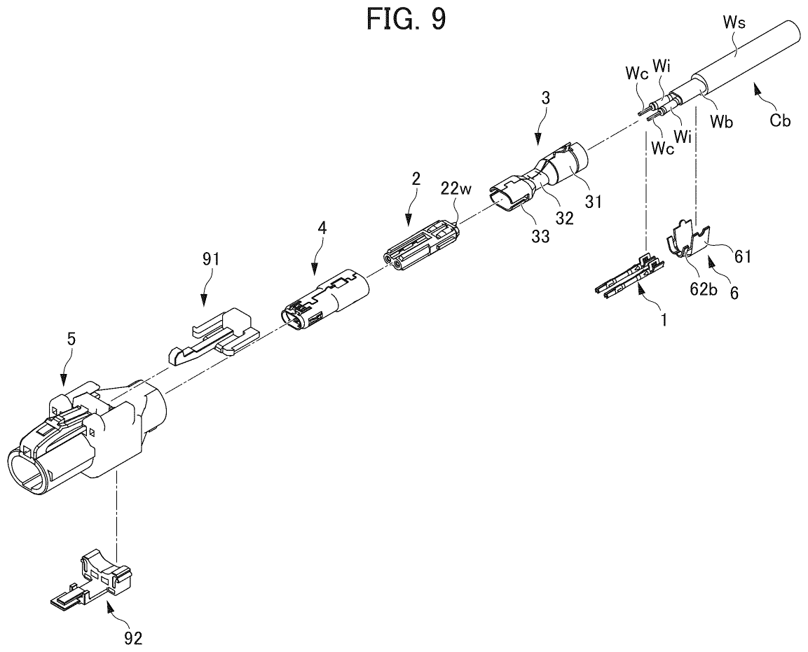

Referring to FIGS. 6A, 6B, and 9, the terminal conduction hole portion 32 has a smaller outer shape than the crimp portion 31 and the connecting portion 33. Referring to FIG. 5, with the metal shell 3 and the cover shell 4 joined with the shielded cable Cb and assembled with an outer housing 5, a U-shaped second positioning member 92 is inserted into the outer housing 5 from below (see FIG. 6A) to ensure the position of the metal shell 3 relative to the outer housing 5 in the axial direction of the metal shell 3.

### (Configuration of Cover Shell)

The configuration of the cover shell 4 according to the embodiment will be described below. Referring to FIGS. 5 to 7, the cover shell 4, which is made of a conductive metal plate, is obtained by forming a developed conductive metal plate into an elliptic tube shape.

Referring to FIG. 8A or 8B, a proximal end of the cover shell 4 fits with a distal end of the metal shell 3 to be in close contact. The cover shell 4 is connected to the metal shell 3 in series in the axial direction. The cover shell 4 is electrically connected to the metal shell 3 (see FIGS. 6A and 6B).

Referring to FIGS. 8A to 8D, the cover shell 4 covers the inner housing 2 and the front portion of the metal shell 3. The cover shell 4 holding the inner housing 2 receives the metal shell 3 inserted therein to fit with the metal shell 3.

### (Configuration of Outer Housing)

The configuration of the outer housing 5 according to the embodiment will be described below. Referring to FIGS. 1 to 6B, the outer housing 5 includes a substantially rectangular parallelepiped-shaped body 5b and an elliptical cylindrical header 5h. The body 5b can house therein the metal shell 3 and the cover shell 4 joined with the shielded cable Cb shown in FIG. 5 (they will be hereinafter referred to as a terminal assembly).

Referring to FIG. 1 or 2, the header 5h protrudes from a front surface of the body 5b. The header 5h has a connection opening 51 which can receive a header of a counterpart connector (see FIG. 1). The header 5h houses the cover shell 4 inside (see FIGS. 1 and 8B).

Referring to FIGS. 1 to 6B, the header 5h has a locking arm 5r on the upper surface. The locking arm 5r can fit with a latch member of a counterpart connector which is not shown.

Referring to FIG. 6A or 9, the outer housing 5 has a first positioning member (will be hereinafter referred to as a CPA) 91. With the locking arm 5r locked with the latch member of the counterpart connector, the CPA 91 is inserted into the outer housing 5 from the rear side toward the locking arm 5r and locked with the locking arm 5r, keeping the latch member and the locking arm 5r locked together. This ensures the positioning of the counterpart connector and the outer housing 5.

Referring to FIGS. 1 to 6B, the outer housing 5, which is made of an insulative synthetic resin, can be obtained by molding the insulative synthetic resin into a desired shape having a cavity inside.

Referring to FIG. 6A or 9, the outer housing 5 also includes a rectangular parallelepiped-shaped second positioning member (will be hereinafter referred to as a TPA) 92. The body 5b has a rectangular opening that can receive the TPA 92 at the bottom. The opening communicates with the cavity inside the body 5b.

Referring to FIG. 6A or 9, the terminal assembly is inserted into the outer housing 5 from the rear side (see FIG. 5), and the TPA 92 is inserted into the opening at the bottom of the body 5b from below with the terminal assembly At fitted in the outer housing 5. Then, an arc surface of the TPA 92 (see FIG. 6A) makes contact with the terminal conduction hole portion 32 of the metal shell 3 (see FIG. 9). Specifically, the opening is formed at an axial position where the TPA 92 makes contact with the terminal conduction hole portion 32.

Referring to FIG. 6A or 9, the terminal conduction hole portion 32 is narrower than the crimp portion 31 and the connecting portion 33. Thus, when the TPA 92 is attached to the outer housing 5, the TPA 92 can restrict the axial movement of the metal shell 3 relative to the outer housing 5 (see FIG. 8B).

(Method of Assembling Shield connector)

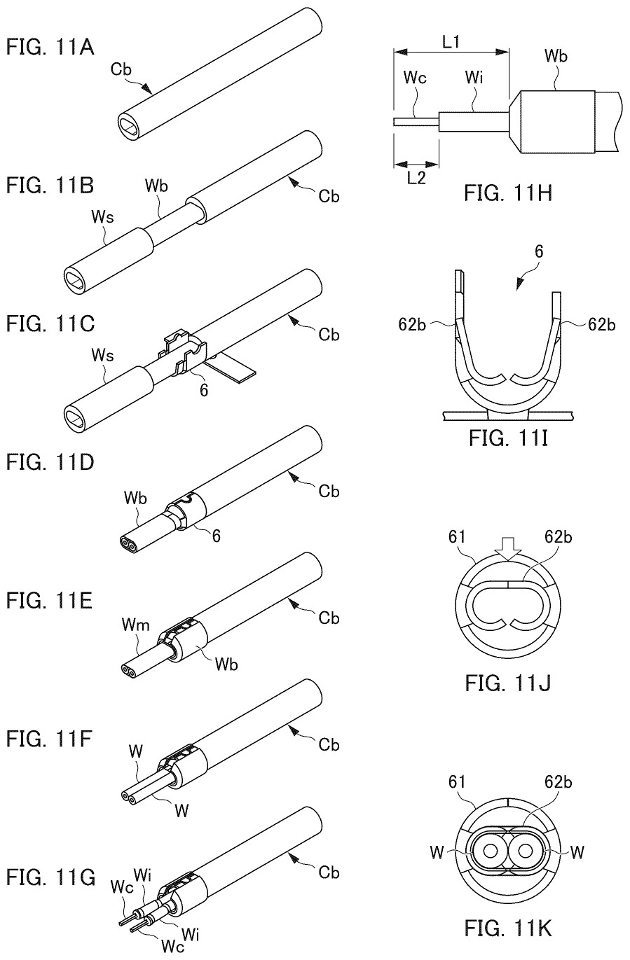

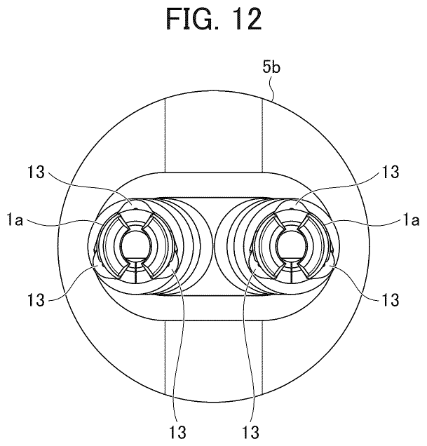

How the connector 10 according to the embodiment is assembled will be described below. First, the shielded cable Cb is terminated as shown in FIGS. 11A to 11K.

The insulation sheath Ws alone is peeled off the unterminated shielded cable Cb shown in FIG. 11A while leaving a predetermined length from the end face of the shielded cable Cb (see FIG. 11B). Then, the ferrule 6 in an open state is set on the braided wire Wb (see FIG. 11C) exposed on the shielded cable Cb partially stripped as shown in FIG. 11B. Referring to FIGS. 11I to 11K, the ferrule 6 has a first crimp portion 61 and a pair of second crimp portions 62b, 62b. The ferrule 6 is then crimped onto the braided wire Wb (see FIG. 11D). The ferrule 6, which is in the shape of a U-shaped open crimp barrel as shown in FIG. 11I, is bent to be crimped onto the braided wire Wb. Referring to FIG. 11J, once the ferrule 6 is bent, the second crimp portions 62b, 62b are reduced in diameter in a direction from the first crimp portion 61 to the second crimp portions 62b, 62b, with their outer edges partially connected to and continuous with the first crimp portion 61. Referring to FIG. 11K, the pair of second crimp portions 62b, 62b is crimped to the braided wire Wb from the outer circumference. Referring to FIG. 11D, the first crimp portion 61 is bent into a cylindrical shape with an air layer left between the first crimp portion 61 and the braided wire Wb. After the crimping, an end of the braided wire Wb is folded over the ferrule 6 (see FIG. 11E). Crimping the braided wire Wb folded over the ferrule 6 with the crimp portion 31 sandwiches the braided wire Wb between the ferrule 6 and the metal shell 3. This allows conduction between the metal shell 3 and the braided wire Wb.

Then, metal foil Wm covering the electric wires W shown in FIG. 11E is removed from the ends of the electric wires W (see FIG. 11F). Then, the insulating covering Wi is removed from the ends of the electric wires W shown in FIG. 11F (see FIG. 11G). Thus, the termination of the shielded cable Cb finishes. As shown in FIG. 11H, the electric wires W are exposed from the end of the shielded cable Cb by a length “L1”, and the core wires Wc are exposed from the ends of the electric wires W by a length “L2”.

Then, referring to FIG. 11G, the core wires Wc exposed at the ends of the electric wires W are inserted into the electric wire connection portions 1a of the terminals 1. Crimping the electric wire connection portions 1a can fix the terminals 1 at the ends of the electric wires W (see FIG. 7).

Referring to FIG. 7, the electric wires W joined with the pair of terminals 1, 1 are inserted into the terminal introduction holes 32h of the metal shell 3 from the rear side of the metal shell 3. With each electric wire W passing through the terminal introduction hole 32h, a truncated cone-shaped portion (the braided wire Wb folded over the ferrule 6) abuts on the wall at the end of the crimp portion 31 to stop the shielded cable Cb relative to the metal shell 3. At this time, the insulating covering Wi on each electric wire W enters the terminal conduction hole portion 32 and makes close contact with the inner wall of the terminal introduction hole 32h.

The electric wires W joined with the pair of terminals 1, 1 pass through the terminal introduction holes 32h and enter the terminal introduction holes 21h of the inner housing 2 arranged inside the cover shell 4. In this state, the wedge piece 22w protruding toward the front portion of the metal shell 3 separates the ends of the electric wires W, W at a predetermined pitch. Referring to FIG. 7, each terminal 1 has the contact lance 13 that protuberates from the outer circumference of the electric wire connection portion 1a and is locked with the housing lances 22r formed on the inner wall of the inner housing 2. This keeps the shielded cable Cb from falling off the inner housing 2.

The braided wire Wb is covered with the insulation sheath Ws, the inner housing 2, and the metal shell 3 between the end of the shielded cable Cb and the pair of terminals 1, 1. Thus, the core wires Wc are not exposed to the outside. The metal shell 3 and the cover shell 4 joined with the shielded cable Cb shown in FIG. 5 function as the shield connector, or the terminal assembly At. When the terminal assembly At is mounted on the outer housing 5, the terminal assembly functions as a harness that allows easy connection with the counterpart connector.

The terminal assembly At completed in this manner is inserted into the outer housing 5 from the rear side of the outer housing 5 (see FIGS. 6A and 6B). Then, as shown in FIG. 8B, with the terminal assembly At fixed inside the outer housing 5, the TPA 92 is inserted into the outer housing 5 from below the outer housing 5 (see FIG. 6A or 9). The TPA 92 fitted in the outer housing 5 can restrict the axial movement of the metal shell 3 relative to the outer housing 5.

When the CPA 91 is attached to the outer housing 5 with the locking arm 5r locked with the latch member of the counterpart connector, the latch member and the locking arm 5r can be kept locked together.

### Advantages of Shield Connector

The advantages of the connector 10 according to the embodiment will be described below.

In the connector 10 according to the embodiment, when the pair of terminals 1, 1 are inserted into the terminal introduction holes 21h, 21h, the wedge piece 22w is relatively inserted between the electric wires W, W. When the movement of the pair of terminals 1, 1 is stopped, at least one or two of the three contact lances 13 can be securely latched to the housing lances 22r.

The shield connector 10 according to the present invention can simultaneously insert the terminals 1 into the inner housing 2, even when there is twisting in the terminals 1 wire-connected to the core wires Wc of the pair of electric wires W, W.

Referring to FIGS. 5 to 11H, the connector 10 according to the embodiment allows easy insertion of the electric wires W with the terminals 1 at the tip ends into the terminal introduction holes 21h, and the inner housing 2 has the wedge piece 22w protruding from the end of the inner housing 2. Thus, the ends of the pair of electric wires W, W in close contact can be separated from each other at a predetermined pitch.

Referring to FIGS. 1 to 6B, the connector 10 according to the embodiment has the CPA 91 (the first positioning member) that keeps the latch member and the locking arm 5r locked together, ensuring the positioning of the counterpart connector and the outer housing 5.

Referring to FIG. 6A or 9, the connector 10 according to the embodiment has the TPA 92 (the second positioning member) that is inserted into the outer housing 5 from below toward the terminal conduction hole portion 32, restricting the axial movement of the metal shell 3 relative to the outer housing 5.

The disclosed embodiment of the shield connector of the present invention is attached to an end of a two-pole shielded cable having a pair of electric wires covered with a braided wire. However, the shield connector of the present invention is also attachable to, for example, an end of a multipole shielded cable having a pair of electric wires covered with a braided wire.

Although the shield connector according to the present invention has been disclosed with a lance configuration applicable to shielded differential cables, this lance configuration can also be applied to coaxial connectors fixed to terminal ends of coaxial cables. Additionally, the shield connector according to the present invention can insert the terminals into the housing without considering orientation, even for conventional electric wires other than those described above.

### EXPLANATION OF REFERENCE NUMERALS

1: terminal
1a: electric wire connection portion
1b: terminal connection portion
2: inner housing
3: metal shell
4: cover shell
10: connector (shield connector)
13: contact lance (latching protrusion)
32h: terminal introduction hole
22r: housing lance (latching portion)
Cb: shielded cable (shielded differential cable)
W: electric wire
Wc: core wire
Wb: braided wire
Ws: insulation sheath

What is claimed is:

1. A shield connector attachable to a terminal end of a shielded differential cable, the shielded differential cable including a pair of electric wires each including a core wire insulated by an insulating covering, a braided wire covering the pair of electric wires, and an insulation sheath covering the braided wire, the shield connector comprising:
a pair of cylindrical terminals each configured to wire-connect the core wire;
an inner housing internally holding the pair of terminals; and
a metal shell electrically connected to the braided wire, the metal shell covering an exposed portion of the pair of electric wires extending from a terminal end of the braided wire to the terminals in a tightly close-contact manner, and the metal shell including a pair of terminal introduction holes partially communicating with each other at outer edges thereof,
wherein each of the terminals comprises:
an electric wire connection portion provided at one end thereof, the electric wire connection portion including a conductor barrel configured to connect the core wire by crimping;
a terminal connection portion provided at another end thereof, the terminal connection portion including a pair of clipping pieces connectable to a counterpart terminal; and
a plurality of latching protrusions provided on a side adjacent to the electric wire connection portion and protuberating radially outward from an outer circumference of the terminal, and
wherein the inner housing includes a latching portion protruding forwardly and latchable to the latching protrusions.

2. The shield connector according to claim 1, wherein the plurality of latching protrusions comprise three protrusions arranged evenly around the outer circumference of the terminal, and the latching portion comprises a pair of opposing semicircular walls.

3. The shield connector according to claim 1, further comprising an outer housing with an upper surface including a locking arm fittable to a counterpart connector, the outer housing internally holding the metal shell in a state of being connected to the shielded differential cable,
wherein the outer housing includes a first positioning member configured to maintain a locked state of the locking arm.

4. The shield connector according to claim 3, wherein the outer housing further includes a second positioning member inserted from a lower surface toward an outer circumference of the metal shell, thereby restricting axial movement of the metal shell relative to the outer housing.

5. The shield connector according to claim 1, further comprising an elliptical cylindrical cover shell serially connected to the metal shell and covering a front portion of the metal shell.
